(19) United States
(12) Patent Application Publication
(10) Pub. No.: US 2015/0032463 A1
(43) Pub. Date: Jan. 29, 2015

(54) SYSTEM AND METHOD FOR COMMUNICATING WITH PHARMACEUTICAL CONSUMERS AND MANAGING DATA RELATED THERETO

(71) Applicant: Pharmasecure, Inc., Lebanon, NH (US)

(72) Inventors: Nakul Pasricha, New Delhi (IN); Nathan J. Sigworth, Hamden, CT (US); Jay S. Kunin, San Diego, CA (US)

(73) Assignee: PHARMASECURE, INC., Lebanon, NH (US)

(21) Appl. No.: 13/950,265

(22) Filed: Jul. 24, 2013

Related U.S. Application Data
(63) Continuation of application No. PCT/US13/51666, filed on Jul. 23, 2013.

(51) Int. Cl. G06Q 50/22; G06Q 30/00

(52) U.S. Cl. CPC G06Q 50/22; G06Q 30/0185
USPC 705/2

(57) ABSTRACT

A system and method that includes communicating with a consumer, in response to receiving a request from the consumer to verify the authenticity of a product, to offer access to one or more services related to the product, receiving a selection by the consumer of at least one of the one or more services, sending a confirmation message to the consumer confirming the selection by the consumer of at least one of the one or more services and enabling the provision of the one or more service to the consumer.

### RELATED APPLICATIONS

This application is a continuation of PCT Application No. PCT/US13/51666, filed Jul. 23, 2013, entitled SYSTEM AND METHOD FOR COMMUNICATING WITH PHARMACEUTICAL CONSUMERS AND MANAGING DATA RELATED THERETO, the entire disclosure of which is herein incorporated by reference, which claims the benefit of U.S. Provisional Application Ser. No. 61/674,520, filed Jul. 23, 2012, entitled SYSTEM AND METHOD FOR COMMUNICATING WITH PHARMACEUTICAL CONSUMERS AND MANAGING DATA RELATED THERETO, the entire disclosure of which is herein incorporated by reference, and of U.S. Provisional Application Ser. No. 61/709,418, filed Oct. 4, 2012, entitled SYSTEM AND METHOD FOR COMMUNICATING WITH PHARMACEUTICAL CONSUMERS AND MANAGING DATA RELATED THERETO, the entire disclosure of which is also herein incorporated by reference.

### FIELD OF THE INVENTION

This invention relates to systems and methods for connecting with consumers, particularly pharmaceutical consumers, and mining information gathered by so doing.

### BACKGROUND OF THE INVENTION

There are several disadvantages related to gathering accurate information regarding, for example, the consumption of pharmaceutical products, as well as other habits and attributes of consumers of pharmaceutical products. Doctors, health organizations, drug manufacturers, pharmaceutical distributors and the like are often times unable to accurately ascertain the consumption and use characteristics of pharmaceutical products to a degree necessary to, for example, measure drug regime compliance, detect the outbreak of disease and contagions, and affirmatively provide reminders to consumers to take medications. In addition, pharmaceutical consumers are often separated from valuable information and services related to pharmaceutical products. For example, information about the effects and nature of various pharmaceutical products, while generally available on the Internet, requires a conscious and affirmative act by the consumer in order to search for such information. As a result, many consumers of pharmaceutical products fail to receive information of importance resulting in the suboptimal outcomes from the ingestion of such products. Further, data describing drug taking habits of consumers, if available, could provide a valuable data resource that could be mined to advance various health initiatives.

Accordingly, it is desirable to provide a system and method for connecting consumers of pharmaceutical products to value added services, particularly services directed to providing information and guidance regarding the use of pharmaceutical products. Such a system should desirably likewise provide a method by which third party individuals such as doctors, drug manufacturers and distributors, and health organizations, among others, can interact with consumers and consumer data in a manner that respects the privacy of the consumers while advancing public health interests.

### SUMMARY OF THE INVENTION

A system for communicating with pharmaceutical consumers and managing data related thereto includes an identification module, a verify (or verification) module and a connect module. The identification module operates, generally, to generate and affix coded product identifiers to pharmaceutical products. A product code that is provided to the identification module by a user is communicated to the verify (or verification) module. The verification module operates to authenticate the product code and inform the consumer as to the authenticity of the product code. Each interaction between a consumer and the verify module generates consumer data that is communicated to a connect module. The connect module includes a business logic layer that facilitates communication between third party service providers, consumers and the data exchanged therebetween.

A method for connecting with a consumer comprises communicating with a consumer, in response to receiving a request from the consumer to verify the authenticity of a product, to offer access to one or more services related to the product, receiving a selection by the consumer of at least one of the one or more services, sending a confirmation message to the consumer confirming the selection by the consumer of at least one of the one or more services and enabling the provision of the one or more service to the consumer.

In accordance with a further illustrative embodiment, a method comprises receiving data describing verification of an authenticity of a product by a consumer, storing the data and mining the data to determine one or more attributes related to the use of the product.

In accordance with an illustrative embodiment, a method comprises providing a doctor with a doctor-patient communication card for distribution to a patient to thereby activate a doctor-patient communication module for communication between the doctor and the patient, then receiving a doctor-patient communication module code from the patient, requesting the doctor-patient communication module to be activated, sending a confirmation to the patient, confirming enrollment in the program, then ascertaining preferences for health tips, refill reminders and appointment reminders from the patient, and finally providing health tips, refill reminders and appointment reminders to the patient for a predetermined amount of time.

### BRIEF DESCRIPTION OF THE DRAWINGS

The invention description below refers to the accompanying drawings, of which:

FIG. 1 is a block diagram of an overall system architecture for connecting pharmaceutical consumers and third party providers of services according to an illustrative embodiment;

FIG. 2 is a perspective view of a mobile device that receives messages for enabling access to services related to products, particularly pharmaceutical products, according to an illustrative embodiment;

FIG. 3 is a flow diagram of a procedure for enabling receipt of refill reminders according to an illustrative embodiment;

FIG. 4 is a flow diagram of a procedure for enabling receipt of health tips reminders according to an illustrative embodiment;

FIG. 5 is a flow diagram of a procedure for providing access to a health advisor/provider of health services according to an illustrative embodiment;

FIG. 6 is a flow diagram of a procedure for mining data acquired via the authentication of encoded products according to an illustrative embodiment;

FIG. 7 is a flow diagram of a procedure for activating a doctor-patient communication module according to an illustrative embodiment;

FIG. 8A is a diagram of a front view of a doctor-patient communication card used in activating the doctor-patient communication module in accordance with the illustrative embodiments; and

FIG. 8B is a diagram of a back view of a doctor-patient communication card used in activating the doctor-patient communication module in accordance with the illustrative embodiments.

### DETAILED DESCRIPTION

A system and method for connecting consumers of pharmaceutical products to value added services, particularly services directed to providing information and guidance regarding the use of pharmaceutical products is provided. As described more fully below, the system operates, via an identification module, to code hundreds of millions of pharmaceutical and neutraceutical products with unique, alphanumeric codes. These codes may be subsequently verified, via a verify (or verification) module, by consumers to authenticate the products via SMS, web, call center, mobile app or other means. A connect module functions as a platform to connect interested healthcare providers with the database of consumers built up through the verify module and, subsequently, to the consumers themselves. Note that as used herein, the term “pharmaceutical product” or “neutraceutical product” is intended to cover either a medicine or a product, or both, or any other package of a pharmaceutical product that is “taken”, consumed or otherwise used by a user and known in the art.

I) Overall System

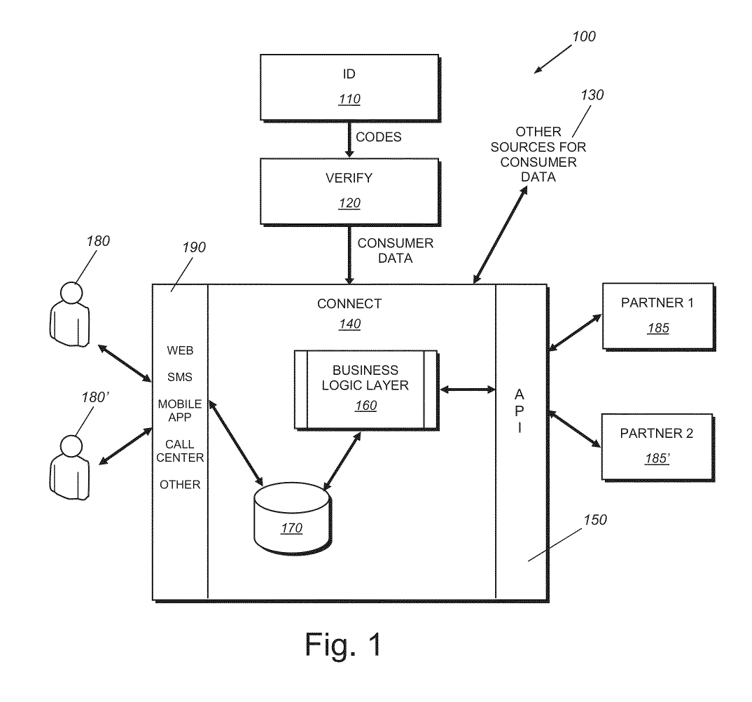

With reference to FIG. 1, a system 100 is shown for practicing various illustrative embodiments. As illustrated, ID (“identification”) module 110 operates, generally, to generate and affix coded product identifiers to pharmaceutical products. In accordance with an illustrative embodiment, generated product codes that are received from a code generation entity (for example at a manufacturing facility) are utilized to print or otherwise affix product codes onto pharmaceutical products. ID module 110 further operates to receive queries from consumers requesting, for example, authentication of the product upon which a product code is affixed. In accordance with various illustrative embodiments, the product codes can be encrypted, or otherwise manipulated, encoded, enciphered, or generated, so as to reduce the incidence of counterfeiting. The product code is a random number that is unique to the package that the code is on. In accordance with an illustrative embodiment, consumer 180 communicates with ID module 110 to authenticate a product code that is affixed to a pharmaceutical product. For example, consumer 180 utilizing a cell phone can dial a number to communicate with ID module 110 and proceeds to “enter” (i.e. type or otherwise provide) the product code affixed to the product, using a user interface comprising a part of cell phone user apparatus. A text message or other appropriate communication can provide requests to ID module 110.

Thereafter, the product code is communicated from the ID module 110 to a verify module 120. Verify module 120 operates to authenticate the product code and to inform the consumer as to the authenticity of the product code and, hence, the product itself For example, verify module 120 can communicate to consumer 180 a message reciting “Product code 4567 having batch number 347 and affixed to 50 count bottle of 20 mg aspirin tablets is authenticated.” Conversely, verify module 120 may communicate with consumer 180 to report an inauthentic, or unauthenticated, product.

Each interaction between consumer 180 and verify module 120 generates consumer data that is communicated to connect module 140. The consumer data includes, for example, a consumer identifier, such as a phone number, an email address and other consumer-related data depending upon the manner by which consumer 180 interacts and communicates with verify module 120, a time of day, a consumer location, a pharmaceutical product identifier, etc. This consumer data is communicated from verify module 120 to connect module 140. It should be clear that each of ID module 110 and verify module 120, while illustrated as logical and functional blocks, can, in practice, be comprised of one or more computing devices such as computers or servers each capable of communicating between and amongst each other to accomplish the actions described above and ascribed to each module 110, 120. Further, each of ID module 110 and verify module 120 can make use of some or all of the same computing devices. In accordance with an exemplary embodiment, all of the functionality described with reference to ID module 110 and verify module 120 can be performed on a single computing device. Communication between modules 110, 120, 140 can be either wired or wireless, such as via the internet or cell phone communication, or other form of communication known in the art.

In accordance with illustrative embodiments, connect module 140 includes database 170 and business logic layer 160 each of which is described in greater detail hereinbelow. As illustrated, connect module 140 is configured to receive consumer data from verify module 120. The consumer data can be stored in database 170 for subsequent retrieval by, for example, business logic layer 160. In addition to consumer data gathered and communicated to connect module 140 from verify module 120, connect module 140 can receive consumer data from other sources for consumer data 130. The other sources can include, for example, census data, epidemiology reports, partner organizations, internet campaigns, manufacturer data and the like. This consumer data may likewise be stored in database 170. The operation of the connect module 140 is shown and described in greater detail herein.

As shown, database 170 is in communication with business logic layer 160. As described in greater detail hereinbelow, business logic layer 160 operates to facilitate communication between third party service providers, or, providers 185 and database 170, between consumers 180 and database 170 and between providers 185 and consumers 180. In accordance with an exemplary embodiment, business logic layer 160 receives inputs from the API (Application Programming Interface) layer 150 and generates a customized campaign to connect with the desired set of consumers. For example, business logic layer 160 receives parameters describing attribute values and ranges for potential targeted consumers and proceeds to retrieve from database 170 consumer identifiers of consumers 180 whose various data attributes fall within the desired parameters. Thus, business logic layer 160 factors in any and all regulatory concerns when identifying and facilitating communication with consumers 180 by providers 185. Because business logic layer 160 is positioned between the origin and terminus of communications between providers 185 and consumers 180, business logic layer 160 operates to protect the privacy and identity of consumers 180.

As described in greater detail hereinbelow, connect module 180 comprises API layer 150 to enable communication by and between providers 185 and business logic layer 160. In accordance with exemplary embodiments, API layer 160 enables healthcare providers, product manufacturers, non-profit organizations or other interested parties comprising providers 185 to reach a subset of consumers whose profile and attendant consumer data is stored in database 170 with their customized message, at an agreed-to cost. As described in greater detail hereinbelow, the selection of a customized message for communication to and display upon a user interface under the control of consumer 180, such as the screen of a smart phone, can involve bidding by providers 185 for access to the limited display space comprising consumer's user interfaces.

In accordance with illustrative embodiments, business logic layer 160 is further enabled to communicate with consumers 180 via communication layer 190.

In accordance with various illustrative embodiments, communication layer 190 facilitates communication between connect module 140 and consumers 180 via communication channels. Communication channels include, but are not limited to, the broad worldwide Internet, cellular telephone messaging and communication, including Short Message Service (SMS) messages, call centers and others known in the art, to enable consumers 180 to sign up for desired services and connect with the associated provider 185 of such services. As described hereinbelow, the resulting system 100 is flexible, scalable and replicable across industries and geographies.

As discussed hereinabove, in accordance with various illustrative embodiments, consumers 180 are enabled to access valuable information and services related to a product. Examples of such services include, for example, SMS reminders for medicine refills, health and nutrition information and connecting with a qualified doctor over the phone, as well as any other services that improve or otherwise strengthen the doctor-patient relationship.

II) Services for Authenticated Products

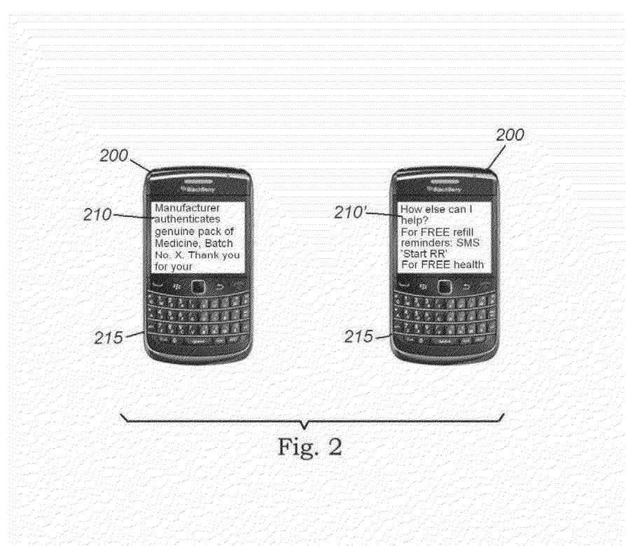

With reference to FIG. 2, an illustrative embodiment of a mobile device is shown by which consumers 180 are presented with the opportunity to access services related to their products, particularly pharmaceutical products. As illustrated, after a consumer 180 communicates with verify module 120 to send an authentication request for a coded product, consumer 180 receives a message 210 such as on mobile device 200 having user interface 215. Message 210 verifies the authenticity of the product at issue. Next, consumer data derived from the authentication process is communicated to connect module 140 which proceeds to communicate a second message 210′ to mobile device 200 presenting consumer 180 with a menu of service options from for selection via user interface 215.

III) Refill Reminders

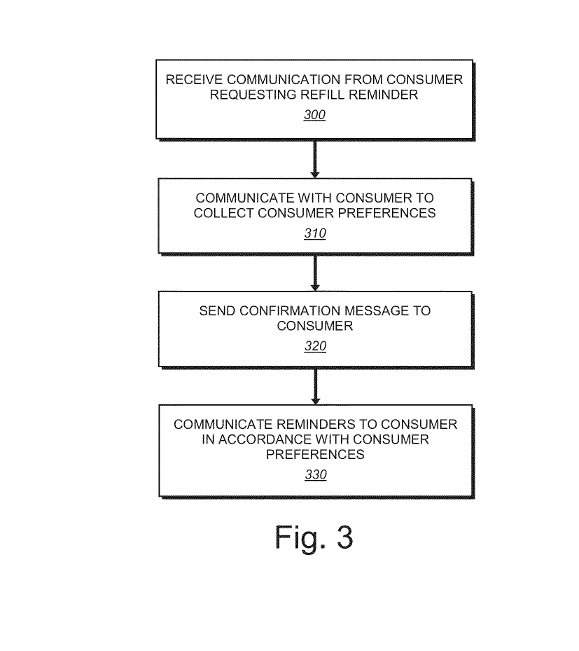

With reference to FIG. 3, there is illustrated a flow diagram of a procedure for enabling refill reminders. Poor compliance in following a regimen, whether for prescription or over the counter products, is a tremendous challenge for consumers 180, health care providers, chemists and manufacturers, resulting in significant losses for the pharmaceutical industry as a whole. Numerous studies have shown that SMS reminders can be a highly effective tool for improving compliance and thereby increasing pharma sales.

In accordance with an exemplary embodiment, at step 300, a communication from a consumer 180 requesting a refill reminder is received. As described herein, such a communication can be received from, for example, a mobile device 200 in response to a consumer 180 selecting a menu option in a message 210′ via a user interface 215. For example, consumer 180 can text “Start RR” to a telephone number associated with connect module 140. The language, text and style of the messages are highly variable within ordinary skill.

Next, at step 310, in response to receiving the request for a refill reminder, connect module 140 proceeds to engage in bi-directional communication with consumer 180 to collect consumer preferences related to the requested reminder. For example, business logic layer 160 engages in bidirectional communication with consumer 180 via communication layer 190 to collect data indicating a start date for the refill reminders, a frequency of refill reminders, an end date for the refill reminders, etc. This data can be stored in database 170.

Next, at step 320, a confirmation message is sent to consumer 180 for presentation such as upon mobile device 200. In accordance with an illustrative embodiment, the confirmation message is sent upon activation of the requested service such as, for example, within twenty-four hours of the reminder request.

Then, at step 330, refill reminders are communicated to consumer 180 in accordance with the received consumer preferences. Specifically, consumer 180 commences to receive communications from connect module 140 as per consumer's requested start date and preferred intervals. As noted, consumers 180 can customize the start date for the service as well as frequency of reminders (weekly, once every 10 days, once every 15 days, or any other frequency desired) as expressed through preferences. Reminder messages generated by connect module 140 may contain fresh, creative content to engage consumer 180 each time. SMS reminders are simple but powerful tool to keep consumers on track and increase sales. In this manner, improved regimen compliance is realized. Further, a one-time purchase of a product by consumer 180 is turned into a recurring interaction providing the opportunity to provide more services and information to consumer 180.

Consumers 180 often desire to make informed decisions about their health. Quality health and nutrition information empowers consumers 180 to lead healthier lives and enjoy the maximum benefit of their product. System 100 allows providers 185 to send regular health tips to individual consumers 180 that are targeted to their particular health needs. Categories of available Health Tips that may be communicated to consumers 180 for display and selection include, for example, healthy diet, aches & pains, seasonal diseases, skin disorders, dental health, men's health, mother & child, sexual health, maintaining work life balance, gastrointestinal disorders, respiratory disorders, endocrine & hormone disorders, ENT disorders and others known in the art.

In accordance with illustrative embodiments, health tips are further customizable by age and gender to ensure that each consumer receives highly targeted, valuable information. In addition to providing content from the above categories such as might be stored in database 170, additional categories may be created that are supported by content supplied by providers 185 and stored in database 170 or in data repositories under the control of providers 185 but accessible to connect module 140 via API layer 150. The provision of such provider specific category selections to consumers 180 may be based upon expressed consumer preferences, demographic attributes associated with a consumer 180 or group of consumers 180, and the like. In other instances, provision of such provider specific category selections to consumers 180 may be based upon attributes associated with providers including, for example, a payment of fee for the placement of a provider's selection on a device 200, such as a mobile device, associated with consumer 180, an auction amongst providers 185, or any other schema wherein the placement of selections from providers 185 involves remuneration from one or more providers 185.

IV) Health Tips

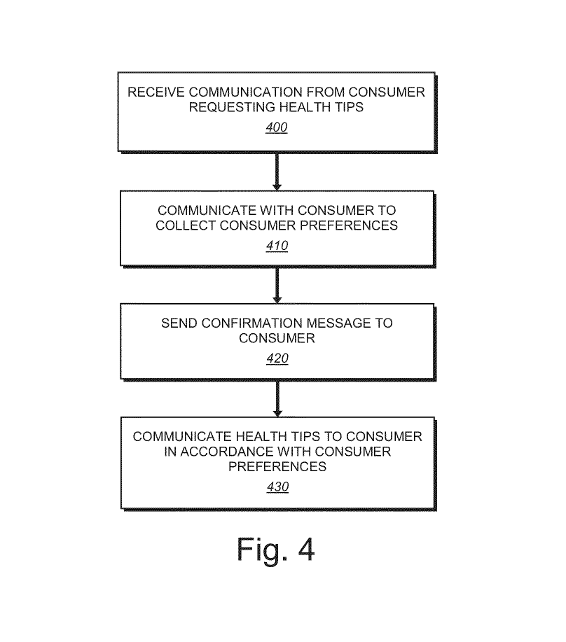

With reference to FIG. 4, there is illustrated a flow diagram of a procedure for enabling health tips. In accordance with the illustrative embodiment, at step 400, a communication from a consumer 180 requesting a refill reminder is received. As described herein, such a communication may be received from, for example, a mobile device 200 in response to consumer 180 selecting a menu option in a message 210′ via a user interface 215. For example, consumer 180 can text “Start HT” to a telephone number associated with connect module 140. The text, style and language of the message are highly variable within ordinary skill.

Next, at step 410, in response to receiving the request for a refill reminder, connect module 140 proceeds to engage in bi-directional communication with consumer 180 to collect consumer preferences related to the requested health tips. For example, business logic layer 160 engages in bidirectional communication with consumer 180 via communication layer 190 to collect data indicating a start date for the health tips, desired categories of health tips, consumer gender and age, mobile number to which the health tips are to be sent, etc. This data can be stored in database 170.

Next, at step 420, a confirmation message is sent to consumer 180 for presentation such as upon mobile device 200. In accordance with an exemplary embodiment, the confirmation message is sent upon activation of the requested service such as, for example, within twenty-four hours of the reminder request.

Then, at step 430, health tips are sent to consumer 180 in accordance with the received consumer preferences. Specifically, consumer 180 commences to receive communications from connect module 140 as per the start date requested by the consumer, desired categories, demographic data and other consumer preferences known in the art.

In accordance with an illustrative embodiment, renewal of a consumer's subscription to receive health tips is dependent on repeat authentication of the product via verify module 120. For example, after a certain time period customizable by consumer 180, consumer 180 will receive the following message, “Enjoying your Health Tips? To renew your free subscription, authenticate your next medicine refill today!” Such messages may be generated by business logic layer 160. The text, style and language of the message are highly variable within ordinary skill.

Poor health literacy can lead to poor compliance with health and nutrition regimens and poor health outcomes. In many cases, doctors and chemists cannot spend sufficient time talking to patients about their condition or how to take their health and nutrition products properly. Connect module 140 can operate to provide consumers 180 the opportunity to speak with medically qualified health advisers, or providers, 185 of medical information, for example over the phone. In accordance with exemplary embodiments health advisers can provide various information and services including, but not limited to, drug information (information on salts, known adverse effects, indications, contra-indications, special precautions, interactions, storage, classification and schedule information), directory information for doctors, specialists, hospitals, pathology labs, chemists Nutrition advice (from a nutritionist), medical advice related to minor ailments such as cough, fever, diarrhea, respiratory infections, backache, joint pain, self-care/home remedies for minor ailments, stress management advice (from a psychologist) and the like.

V) Health Advisor Access

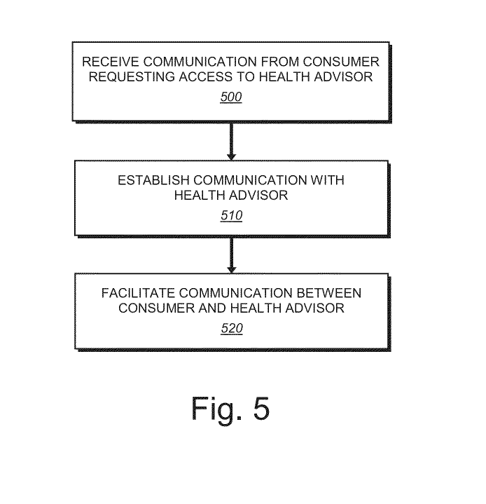

With reference to FIG. 5, there is illustrated a flow diagram of an illustrative embodiment of a procedure for providing access to a health advisor/provider 185 of health services. In accordance with the illustrative embodiment, at step 500, a communication from a consumer 180 requesting access to a health advisor is received. As described hereinabove, such a communication can be received from, for example, a mobile device 200 in response to consumer 180 selecting a menu option in a message 210′ via a user interface 215. For example, consumer 180 can text “Start HA” to a telephone number associated with connect module 140. The text, language and style of the message are highly variable within ordinary skill.

Next, at step 510, in response to receiving the request for a refill reminder, connect module 140 proceeds to establish a connection to a provider 185 of health advice. For example, business logic layer 160 engages in bidirectional communication with provider 185. In an illustrative embodiment, business logic layer 160 can generate one or more alerts to one or more providers 185 informing on-call providers 185 of a consumer 180 generated request to communicate with a health advisor. Business logic layer 160 can then select from amongst responsive providers 185. In another illustrative embodiment, providers can pay or bid for the privilege of responding to a consumer 180 request for a health advisor.

Next, at step 520, communication is facilitated between a responding provider 185 and the requesting consumer 180. In accordance with an illustrative embodiment, business logic layer 160 communicates a phone number of consumer 180 to provider 185 to enable a direct communication from provider 185 to consumer 180. The business logic layer 160 can also, or alternatively, remain involved in the communication by setting up a conference call between provider 185 and consumer 180 to avoid the transfer of consumer's 180 phone number to a third party.

As described hereinabove, as the result of consumers 180 verifying authentication codes affixed to products, particularly pharmaceutical products, and consumers volunteering preferences and demographic data, database 170 is populated with data which can advantageously be mined. In accordance with illustrative embodiments, the system 100 provides a set of tools and data points allowing research and intervention programs to get better information on the distribution and consumption of medicines across diverse populations, as well as to influence the outcomes therein.

Specifically, as discussed hereinabove in accordance with the illustrative embodiments, hundreds of millions of pharmaceutical and neutraceutical products are encoded with unique, alphanumeric codes, by ID module 110. Verify module 120 operates to authenticate these products through communication with consumer 180 via SMS, web, call center, mobile app or other means. Data derived from id module 110, verify module 120 and connect module 140 from, for example, consumers 180 that authenticate product codes in order to achieve a set of objectives related to better health outcomes may be stored in database 170 and accessed or mined to perform original consumer research.

In accordance with the illustrative embodiments, a platform is provided to users that enables a patient to sign up for the platform via verification of one or more pharmaceutical products. The service providers are also authenticated to (or otherwise signed up for) the platform based on interest in accessing a group of targeted consumers. The pharmaceutical manufacturer provides consent (with appropriate commercial considerations) to bundle selected health services with their respective products. Patients are matched to health service providers based upon predetermined criteria, such as therapeutic area, geography, demographics or others known in the art. The services are provided over the platform with appropriate commercial considerations if application. This ability for patients to be offered, in near real-time, health services tailored to their particular ailments, and for healthcare providers to get access to a large group of paying customers (or to monetize their services through pharmaceutical companies paying on behalf of their consumers). The advantages should be clear to those ordinarily skilled in the art.

VI) Data mining of Authenticated Products

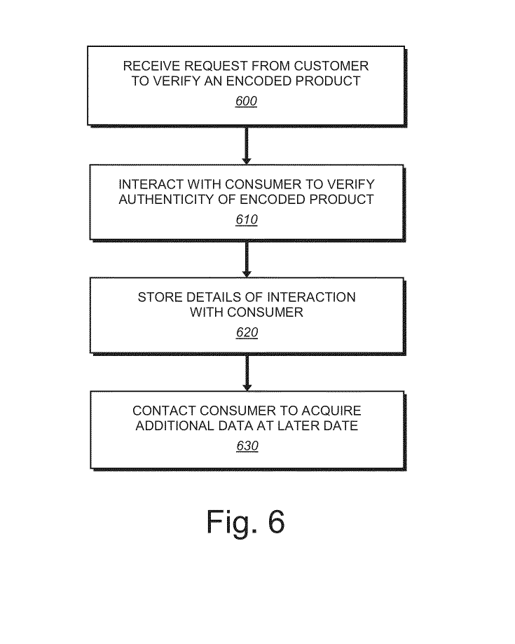

With reference to FIG. 6, a flow diagram is shown of a procedure for mining data acquired via the authentication of encoded products as well as follow up communications with consumers 180. In accordance with the illustrative embodiment, at step 600, a communication from a consumer 180 requesting authentication of an encoded product is received as described above with reference to verify module 120. Next, at step 610 verify module 120 interacts with consumer 180 to verify the authenticity of the product while storing data acquired during the interaction in a database (for example, database 170) at step 620. Examples of data acquired and stored include, for example, mobile number, date of interaction and other relevant data. As noted hereinabove, when such data is communicated to connect module 140, business logic layer 160 operates to assure that the data is stored in compliance with prevailing national laws on data privacy. Notably, business logic layer 160 operates, generally, as a trusted intermediary between requesters of data from database 170, including consumers 180 and providers 185, and the data stored in database 170. In this manner, business logic layer 160 may apply rule based procedures for determining which requesting parties are permitted to see what data and under what circumstances.

Next, at step 630, at one or more days after the first contact with consumer 180, connect module 140 communicates with consumer 180 in order to get certain information (i.e. conducts longitudinal consumer research), which may include, for example, demographic details, details about illness for which medication is being taken, satisfaction information, and interest levels in other products.

Information obtained during the multiple contacts with consumer 180 can be stored and furthermore analyzed, for example by interested third parties granted access to database 170. This allows interested individuals to better understand consumer behavior and drug distribution patterns, as well as to draw insights on how to achieve desired outcomes. This information is valuable to healthcare analytics organizations, manufacturers, public health organizations as well as governments. Amongst the many advantageous results enabled by collecting and mining such data are measurement of adherence and persistence rates among patients, studies of and implementation triggers for improving adherence and persistence rates, measurement of the extent of and prevent drug diversion issues, provision of better market intelligence to drug manufacturers and the like.

Further applications of data mining database 170 include the ability to conduct longitudinal consumer research studies of patients that are taking, for example, a hypertension medication to measure dropout rates after 30 days, 60 days, and 90 days. Further, physician providers 185 can be enabled to call, via connect module 140, recipients of AIDS medications in underserved areas to ensure that medicines are being received in a timely manner, and not being diverted from the system to illegal channels. Further, one may implement a “Mobile DOTS” (Directly Observed Therapy, Short-Course, “DOTS”) program to improve health outcomes for TB, Malaria or other patients through having patients authenticate every dose they take, and following up with the patients who do not take their medication. DOTS is a treatment methodology used for tuberculosis. The “mobile” indicates that instead of the therapy being “directly observed” (i.e., in person), it can be remotely observed using a mobile device. In addition, one may measure sales fluctuations on a region by region basis for a particular drug brand, identifying areas where people might be switching to competitors' products, enabling more effective allocation of sales resources.

In accordance with other illustrative embodiments, connect module 140 may receive, from verify module 120 and store in database 170, information indicative of tertiary, secondary and primary product codes so as to equip distributors, stockists, chemists and other people in the supply chain to register a package thus allowing for multiple levels of tracing the distribution through the supply chain. For example, a chemist has a mobile phone and can authenticate by taking a photo of the 2D bar code on the secondary package. This data is combined with production data of that package and consumer 180 authentication of the packages within to show time and location at multiple places in the distribution.

VII) Doctor-Patient Communication Module

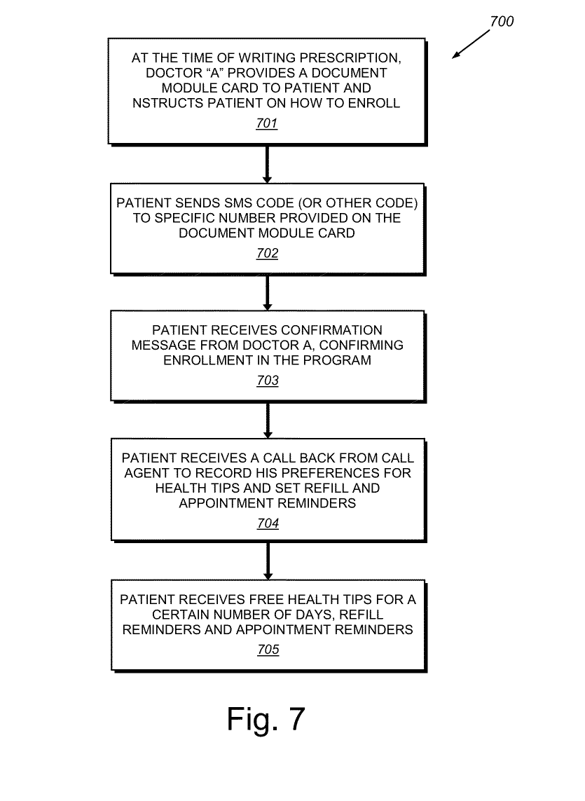

In accordance with an illustrative embodiment, the doctor-patient communication module enables manufacturers to provide a platform for doctors to be able to stay connected with their patients. With reference to FIG. 7, a flow diagram of a procedure for activating a doctor-patient communication module is shown. Once enrolled, the patient is provided with a variety of services that strengthen the doctor-patient relationship, for example the patient can be updated with relevant health tips, refill reminders and appointment reminders. The services provided can be customizable within ordinary skill for various clients as so desired.

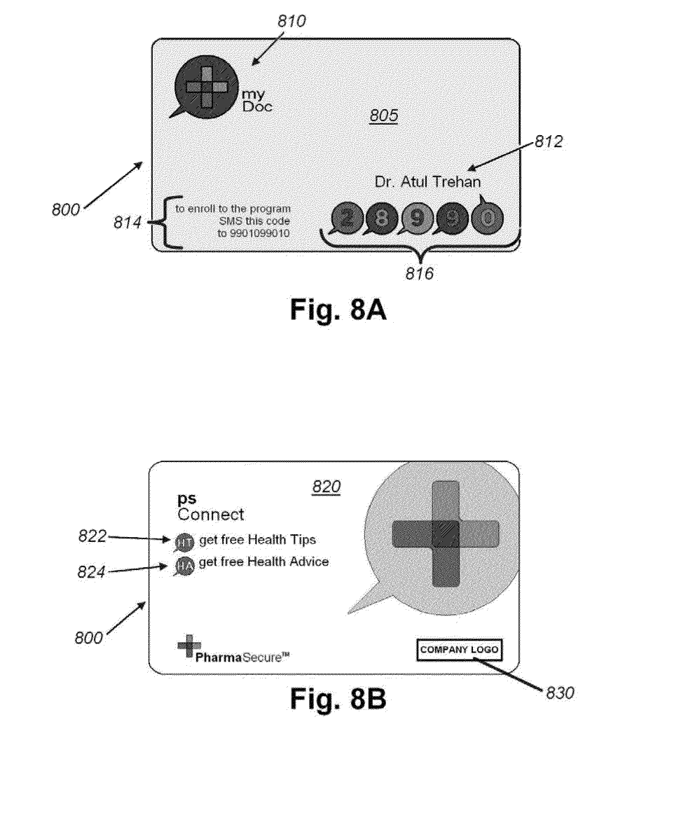

The doctor-patient communication module is activated at the doctor-patient level by performing the steps shown in FIG. 7. The procedure 700 commences at step 701 when, at the time of writing a prescription, a doctor “A” provides a doctor-patient communication card (see, for example, the doctor-patient communication card 800 of FIG. 8) to the patient. Also at step 701, the doctor instructs the patient on how to enroll in the doctor-patient communication module. In an exemplary embodiment, the doctor-patient communication module can be termed the “myDoc” module for quick reference by a patient. At step 702, a patient sends an SMS message (or other appropriate code known in the art) to a specific phone number (or other location or address, such as an IP address or URL) that is listed on the doctor-patient communication card. Thereafter at step 703, the patient receives a confirmation message from doctor A, confirming enrollment of the patient in the program. For example, a user can receive a confirmation message that reads: “Dear Customer, Welcome to MyDoc! You are now eligible to receive FREE Health Tips, Refill Reminder and Appointment reminder. Our agent will call you back shortly to register your preferences. Sincerely, Dr. Atul Trehan. T&C:tiny.cc/99010”.

Shortly thereafter, at step 704, the patient is enrolled in the program by being contacted by a call agent, or to be enrolled automatically, to record the preferences for the various services (such as health tips, refill reminders and appointment reminders for the patient). A call agent is typically provided by the entity in charge of the connect module (as shown in FIG. 1), however this can be an agent assigned by the provider or any appropriate agent for obtaining the preferences of a particular patient. Finally, at step 705, the patient receives free services (such as free health tips, refill reminders and appointment reminders) for a predetermined amount of time. For example, the patient can receive free health tips for 30 days, 2 free refill reminders and 1 free appointment reminder. The predetermined number of incidents or amount of time is highly variable within ordinary skill to achieve the desired health tips, refill reminders and appointment reminders for a patient.

During the procedure to activate the doctor-patient communication module, and enroll the patient in the program, the patient can also be provided with an “opt-out” response, in which they are provided with the option to opt out of the program. An example of an opt-out response includes: “Dear Customer, We hope you are enjoying your enrollment in myDoc program. If at any time you wish to unsubscribe from the program, SMS STOP to 9901099010”. An exemplary appointment reminder response to a patient can include: “Dear Subscriber: Your health is in your hands. This is a reminder for your doctor's appointment. Your reminder was set for <Date>. Sincerely, Dr. Atul Trehan”. These messages are only exemplary and for illustrative purposes only. The actual messages employed can be highly varied within ordinary skill and designer style and choice. The messages can also be user-specified to have particular aspects as desired within user preferences.

The doctor-patient communication module can be part of other features available through the communication layer 190 of FIG. 1, or can be an add-on standalone module, or incorporated within the connect module 140, not shown but apparent to those having ordinary skill in the art.

Reference is now made to FIGS. 8A and 8B showing, respectively, a front and back view of a diagram of a doctor-patient communication card 800. In accordance with an illustrative embodiment, the doctor-patient communication card 800 has a front face, shown in FIG. 8A, which can include an icon 810 for the doctor-patient communication program provided, as well as the name of the doctor 812. The doctor-patient communication card also includes a message 814 with instructions to the patient as to how to enroll in the program. The card 800 also includes a code 816 which is provided to the number or location identified in the code 814 for enrollment into the program. The back side 820 of the doctor-patient communication card 800 includes further details for obtaining information, including the code 822 to obtain health tips and 824 for obtaining health advice. The back side 820 of the card can also include a company logo 830 if so desired. The location, style and format of the card and its contents is highly variable within ordinary skill so long as the pertinent data is provided on the card to allow for enrollment in the doctor-patient communication module program shown and described herein.

The various features and advantages of this system should now be apparent. The systems and methods described herein afford enhanced communication between patients and doctors by providing the desired platforms that enable communication therebetween and gathering of pertinent data. Authentication of pharmaceutical products, and communication between consumers and physicians, is improved and facilitated by systems and methods shown and described herein.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present invention, what has been described herein is merely illustrative of the application of the principles of the present invention. For example, the procedures have been described with reference to managing medicines or particular drugs or other products provided by a pharmaceutical company. However, the teachings herein are readily applicable to any medicine that is sold or distributed, for which data is available. Additionally, the systems and applications herein are described as residing on a particular computing environment, database structure or client-server architecture. However, the type and arrangement of systems and components is highly variable within ordinary skill to achieve the functions described herein. In addition, any of the procedures, functions and/or processes described herein can be performed using electronic/computer hardware, software consisting of a non-transitory computer-readable medium of program instructions, or a combination of hardware and software. Furthermore, the user of directional and/or locational terms such as “front”, “back”, “up”, “down”, “above” and “below” should be taken as relative conventions only, and not as absolute. Accordingly, this description is meant to be taken only by way of example, and not to otherwise limit the scope of this invention.

What is claimed is:

1. A method comprising the steps of:
receiving a request from a consumer to verify authenticity of a product based upon a particular identification code associated with the product;
sending a communication to the consumer, in response to receiving the request from the consumer, to offer the consumer access to services related to the product;
receiving a selection by the consumer of one or more of the services;
sending a confirmation message to the consumer confirming the selection by the consumer of the one or more of the services; and
enabling access to the one or more of the services to the consumer.

2. The method as set forth in claim 1 wherein the request from the consumer is sent over a network comprising the Internet or a cellular telephone network.

3. The method as set forth in claim 1 wherein the services comprise dosage reminders, refill reminders, health tips, a health advisor or any other mHealth service or consumer interaction service.

4. The method as set forth in claim 1 further comprising mining data related to the one or more of the services accessed by the consumer.

5. The method as set forth in claim 1 further comprising enabling a doctor-patient communication-module that facilitates communication between the consumer and a doctor of the consumer.

6. A method comprising the steps of:
receiving data from a consumer, such that the data verifies an authenticity of a pharmaceutical product;
storing the data generated via consumer verification; and
mining the data generated via consumer verification to determine one or more attributes related to the use of the product.

7. The method as set forth in claim 6 wherein the data received from the consumer is stored and analyzed by interested third parties.

8. The method as set forth in claim 6 wherein the data received from the consumer is used for longitudinal consumer research studies.

9. The method as set forth in claim 9 wherein the longitudinal consumer research comprises measuring dropout rates, measuring patient health outcomes or measuring other changes in consumer behavior at predetermined intervals of 30 days, 60 days and 90 days as compared to initial use of the product.

10. The method as set forth in claim 6 further comprising enabling a doctor to directly call the consumer.

11. The method as set forth in claim 6 further comprising implementing a mobile DOTS program or other program to remotely monitor patient adherence to a prescribed course of medication

12. The method as set forth in claim 6 further comprising measuring sales fluctuations on a region-by-region basis.

13. The method as set forth in claim 6 further comprising:
providing a doctor with a doctor-patient communication card for distribution to a patient to thereby activate a doctor-patient communication module for communication between the doctor and the patient;
receiving a doctor-patient communication module code from the patient, requesting the doctor-patient communication module to be activated;
sending a confirmation communication to the patient, confirming enrollment in the program;
ascertaining preferences for services of the patient; and
providing services to the patient for a predetermined amount of time based upon the preferences for services of the patient.

14. The method as set forth in claim 13 wherein the confirmation communication comprises a text message, an electronic mail, a voicemail message, a social media-based message or other software-based interface.

15. The method as set forth in claim 13 wherein the doctor-patient communication card comprises a software-based electronic card.

16. The method as set forth in claim 13 wherein the doctor-patient communication card comprises a physical card having information displayed thereon.

17. A method comprising the steps of:
providing a user with a platform for services upon verification of one or more of a plurality of pharmaceutical products;
receiving consent from pharmaceutical manufacturer of the pharmaceutical product to combine services with the pharmaceutical product;
matching the user to one or more service providers that have been authenticated to the platform, based upon predetermined service provider-related criteria; and
providing services over the platform to the user.

18. The method as set forth in claim 17 wherein the predetermined service provider-related criteria comprise therapeutic area, geography or demographics.

19. The method as set forth in claim 17 wherein the services are provided over the platform by a third party with commercial considerations.
